(19) United States
(12) Patent Application Publication
(10) Pub. No.: US 2006/0271620 A1
(43) Pub. Date: Nov. 30, 2006

(54) Digital music social network player system

(76) Inventors: Robert M. Beaty, Plano, TX (US); Darrell D. Seal, Allen, TX (US)

Correspondence Address: AKIN GUMP STRAUSS HAUER & FELD, LLP, P O BOX 688, DALLAS, TX, 75313-0688, US

(21) Appl. No.: 11/305,918

(22) Filed: Dec. 19, 2005

Related U.S. Application Data
(60) Provisional application No. 60/685,585, filed on May 27, 2005.

(51) Int. Cl. G06F 15/16

(52) U.S. Cl. 709/203

(57) ABSTRACT

A networked database is provided that contains a plurality of records having lists of digital music files for listeners along with relational data containing reviews and comments submitted by other individuals previously selected by the user. Furthermore, each of the previously selected individuals may have another plurality of additional individuals which they have selected that may review and comment on the listener's music files. Each individual in the relationship chain has the ability to view, review and comment on any digital music file which is visible throughout the related chain of individuals as determined by the relational database. Furthermore, when the listener plays a digital file on a mobile device, the relational networked information is available to the listener, including but not limited to, reviews and comments submitted by each individual as well as a visual representation of the submitter which may be a photograph, icon or other graphical symbol and a cumulative rating submitted by distinct groups of individuals.

### CROSS-REFERENCE TO RELATED APPLICATIONS

This application claims the benefit under 35 U.S.C. § 119(e) of U.S. Provisional Patent Application No. 60/685,585, filed May 27, 2005, which is incorporated herein in its entirety for all purposes.

### COMPACT DISC APPENDIX

The U.S. Provisional Patent Application No. 60/685,585 includes an Appendix submitted with the provisional application on one compact disc having a file named appendix.txt, created on May 25, 2005, and having a size of 63,488 bytes. The compact disc is incorporated by reference into the present patent application.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

1. Field of the Invention

The present invention is directed to a networked system built upon a database and Web server which is capable of managing listeners' music file lists as well as storing and retrieving individual's reviews and rating of each song, along with other personal information for each reviewer, such as a photograph or other graphic symbol representing each reviewer. Furthermore, the listener can opt to have the digital music player automatically play music files as determined by their cumulative rating, sorting from highest to lowest or lowest to highest. As a listener listens to music files, the digital music player can then display a plurality or summary of information related to the music file, including reviews and ratings submitted by the user's social circle.

2. Background

The concept of playing music files on devices is a popular one. However, today's mobile devices which can act as music players and pc based digital music players are disconnected islands. They do not provide a means for listeners to review and comment on each other's music. Today's music players neglect the social aspects of music and typically only display artist, album name and other basic information from the music file. Today's listener desires a more social approach which can incorporate other opinions which they respect, even when listening to music on personal computer or a personal device such as a wireless mobile device.

Today's digital music players, including services which provide music downloads via a direct physical connection to a PC as well as wireless download services, do not provide a mechanism where listeners and people in their social circles can interact with each other by providing related reviews and other information based upon the listener's music while the listener plays digital music files.

### BRIEF SUMMARY OF THE INVENTION

The present invention provides a system in which a plurality of related individuals can interact and communicate with each other by providing a variety of information related to each individual's music files which can be displayed automatically by a digital music player while each song is being played or provide expanded review details at the user's request.

In one embodiment, the digital music is played on a mobile device. The music files are uploaded to the mobile device using a physical connection such as a cable or cradle which is connected via a computer to an electronic network. As files are uploaded in this manner on the device, the computer software communicates with a remote Web service using http over the Internet in order to update the list of music files in the remote networked database.

Alternately, in some forms of the present invention this music file information may be transferred directly to the mobile device over a wireless communications network using the built in device modem as each song is accessed by the listener.

Another embodiment of the invention may only involve a pc-based digital music player communicating over a communications network such as the Internet, without the need for any mobile device at all.

As the listener starts to play a song on their digital music player, the software on the mobile device or personal computer downloads related reviews provided by reviewers in their social circles from the remote Web server or from persistent on-device memory or physical storage. In the preferred embodiment the review data is retrieved directly from the Web Server. Another embodiment allows for the reviews to be downloaded to a mobile device over a physical connection to a personal computer and then stored in the mobile device's memory or storage. The software manages the reviewers included in the listener's social circles through a plurality of records which contain a list of friends or other individuals which are in some way related to the listener. The software further displays consolidated ratings or ratings and reviews for each user on the display of the digital music player. The software further provides a means for the listener to rate their songs as well as browse and rate the other reviewer's songs and store that information in the networked database accessed via the Web server.

In a preferred embodiment, the need for a physical connection for uploading music files to a mobile device can be bypassed by having the client software directly download music files from one or more remote servers over standard HTTP or HTTPS Internet protocols using a form GET or POST command or industry standard XML or, alternately, a TCP/IP connection. The embodiment of the current invention allows for digital music files to be downloaded ahead of time or on-demand streaming. These files may be transferred using existing music download services such as iTunes or Napster as well as other popular wireless music download services. As the listener starts to play a song on their digital music player, the software downloads related reviews provided by reviewers in their social circles from the remote Web server as described in the invention or from persistent on-device memory or storage local to the mobile device or personal computer if the data has been previously retrieved. The software manages the reviewers included in the listener's social circles through a plurality or records which contain a list of friends or other individuals which are in some way related to the listener's social circles. The software further displays consolidated ratings or ratings and reviews for each user on the display. The software further provides a means for the listener to rate their songs as well as browse and rate the other reviewer's songs and store that information in the networked database accessed via the Web server.

One preferred embodiment of the present invention comprises a networked database system having at least the following elements:
a. An electronic network supporting wired or wireless Internet connectivity via HTTP, HTTPS or TCP/IP;
b. A Web server or equivalent connected to the electronic network;
c. A database containing a plurality of records;
d. A database server connected to the database for handling operations on the database;
e. A means for connecting to the database; and
f. A mobile device capable of playing digital music.

The database server is responsive to the logic contained on the Web server and is responsible for maintaining related groups of individuals along with a plurality of records containing reviews and ratings relating to individual reviewers, along with a plurality of records containing each individual's own digital music file lists. The Web server, in turn, is capable of transmitting related reviews and rating for each digital music file in a compatible format, using the electronic network, which can be interpreted by the software residing on the mobile device, and which can, in turn, display the related information such as reviews, comments and photographs for each digital music file as it is being played or listed in play lists.

Another preferred embodiment of the present invention comprises a networked database system having at least the following elements:
a. An electronic network supporting wired or wireless Internet connectivity via HTTP, HTTPS or TCP/IP;
b. A Web server or equivalent connected to the electronic network;
c. A database containing a plurality of records;
d. A database server connected to the database for handling operations on the database;
e. A means for connecting to the database; and
f. A personal computer with a digital music player

The database server is responsive to the logic contained on the Web server and is responsible for maintaining related groups of individuals along with a plurality of records containing reviews and ratings relating to individual reviewers, along with a plurality of records containing each individual's own digital music file lists. The Web server, in turn, is capable of transmitting related reviews and rating for each digital music file in a compatible format, using the electronic network, which can be interpreted by the digital music player software residing on the pc, and which can, in turn, display the related information such as reviews, comments and photographs for each digital music file as it is being played or listed in play lists.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, the drawings and the Appendix show an embodiment that is presently preferred. However, the invention is not limited to the precise arrangements and instrumentalities shown. In the drawings:

FIG. 1a is a block diagram of one wired embodiment of the present invention depicting a social networked mobile digital music player downloading music files to the device.

FIG. 1b is a block diagram of one wireless embodiment of the present invention depicting a social networked mobile digital music player downloading music files wirelessly.

FIG. 1c is a block diagram of an embodiment of the present invention depicting the sequence shown in FIGS. 2-8 which occurs during playback of music files using a social networked mobile digital music player.

FIG. 1d is a block diagram of one wired embodiment of the present invention depicting a social networked mobile digital music player downloading music files to the device from a music server incorporated into the present invention.

FIG. 1e is a block diagram of one wired embodiment of the present invention depicting a social networked mobile digital music player downloading music files to the device from a music server and downloading reviews to the device, both via the user's personal computer.

FIG. 2 is a flow diagram representing an embodiment of the present invention of a social networked mobile digital music player depicting the initial logical sequence of playing a social networked digital music file.

FIG. 3 is a flow diagram representing an embodiment of the present invention of a social networked mobile digital music player depicting the second portion of the logical sequence playing a social networked digital music file.

FIG. 4 is a flow diagram representing an embodiment of the present invention of a social networked mobile digital music player depicting the process of adding a song review to a social networked music player.

FIG. 5 is a diagram representing an embodiment of the user interface of the present invention of a social networked mobile digital music player depicting the basic music controls.

FIG. 6 is a diagram representing an embodiment of the user interface of the present invention of a social networked mobile digital music player depicting a social networked review list for a social networked song.

FIG. 7 is a diagram representing an embodiment of the user interface of the present invention of a social networked mobile digital music player depicting a detailed review for a social networked song.

FIG. 8 is a diagram representing an embodiment of the user interface of the present invention of a social networked mobile digital music player depicting the form used to add a review to the social networked song.

FIG. 9 is a diagram representing an embodiment of the user interface of the present invention of a social networked mobile digital music player depicting a compact form of the user interface.

FIG. 10a is a block diagram of a pc-based embodiment of the present invention depicting a social networked digital music player downloading music files to the pc.

FIG. 10b is a block diagram of a pc-based embodiment of the present invention depicting the sequence shown in FIGS. 2-8 which occurs during playback of music files using a social networked digital music player.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

1. Definitions

The following definition is provided to promote an understanding of the present invention:

Social circle or social network (hereafter, “social circle”): a social circle is a defined grouping of one or more individuals pre-selected by the user. An individual user may be in more than one social circle.

2. Description

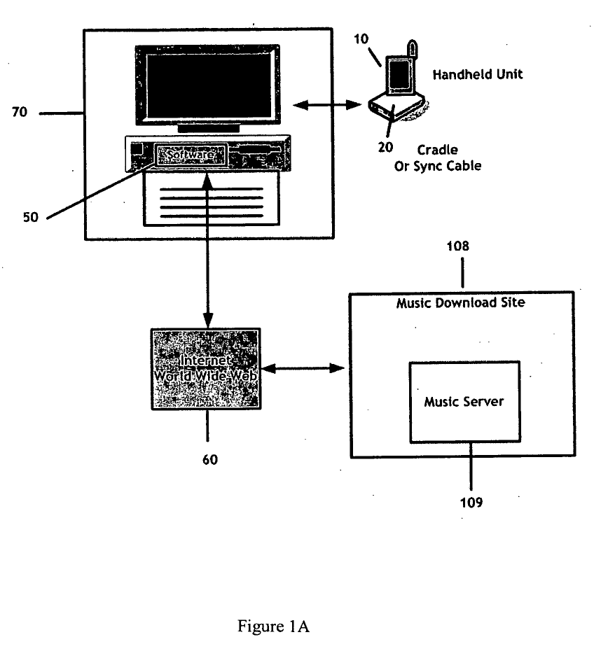

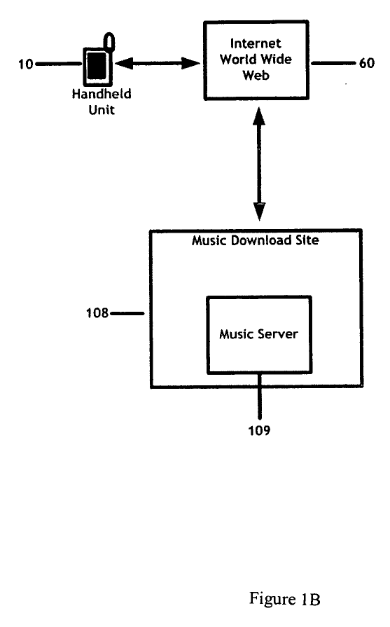

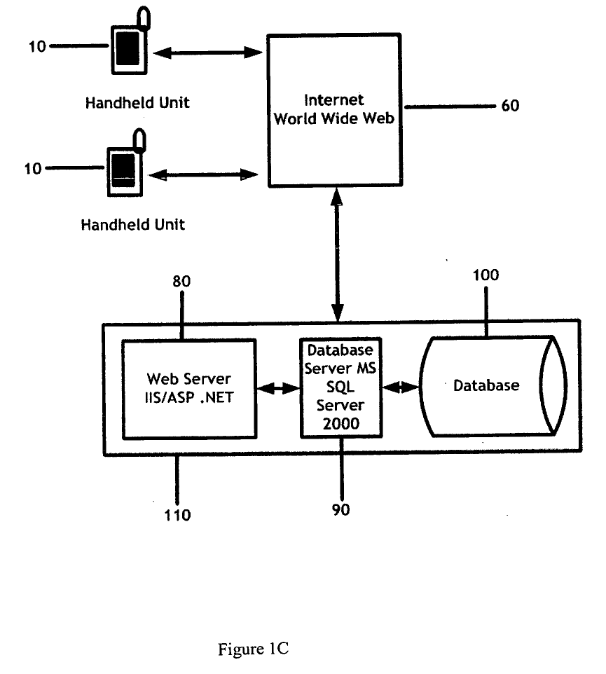

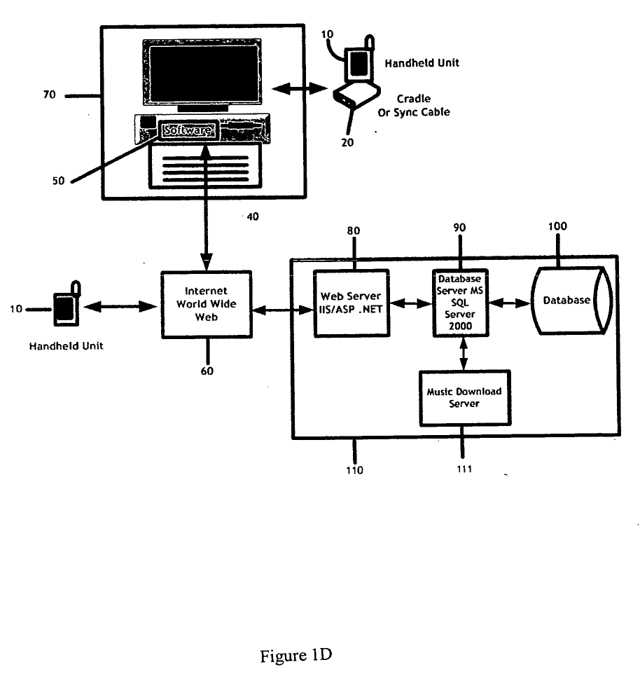

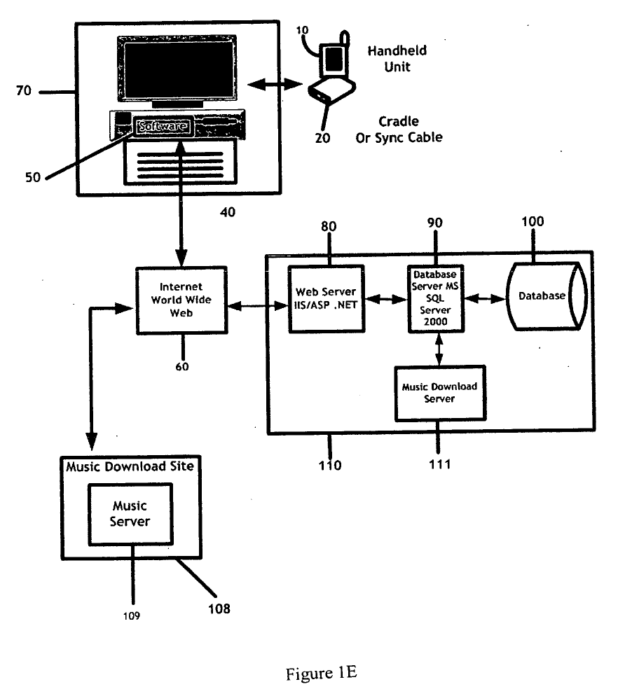

FIG. 1a shows a social networked mobile digital music player system (SNMPS) accordance with one preferred embodiment of the present invention which downloads music files to the mobile device using a physical connection, such as a cable or cradle, connected to a computer which, in turn, is connected to an electronic network.

The computer 70, is coupled to an electronic network 60, and in turn to a music server 109 at a music download site 108, such as Napster or Apple iTunes Music Store. One example of the electronic network is the Internet. The computer 70 is typically a personal computer such as a Microsoft Windows-based workstation, having memory 50 containing communications software which interacts with a mobile device 10 through a physical connection with a cradle or synchronization cable 20. The memory 50 resident software has a means to communicate over a network 60 in order to download music files to the mobile digital music player via a physical connection to a computer 70. Digital music files are retrieved by the user through a music download site 108 that incorporates a music server 109 containing a singularity or plurality of digital music files and then stored on the user's personal computer.

FIG. 1b shows a SNMPS accordance with one preferred embodiment of the present invention. The SNMPS includes a mobile digital music player 10, which is coupled to a wireless network 60, and in turn to a music server 109 at a music download site 108 such as Napster or Apple iTunes Music Store. The mobile digital music player 10 has a means to communicate over a network 60 in order to wirelessly download digital music files.

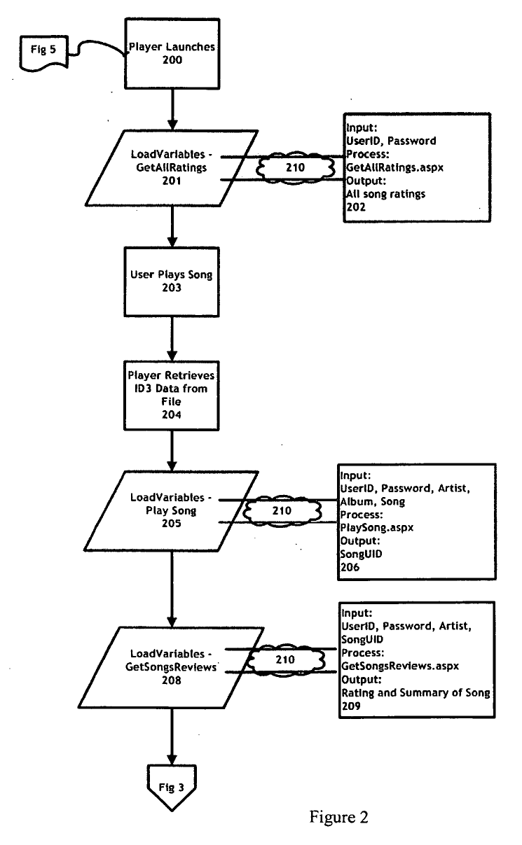

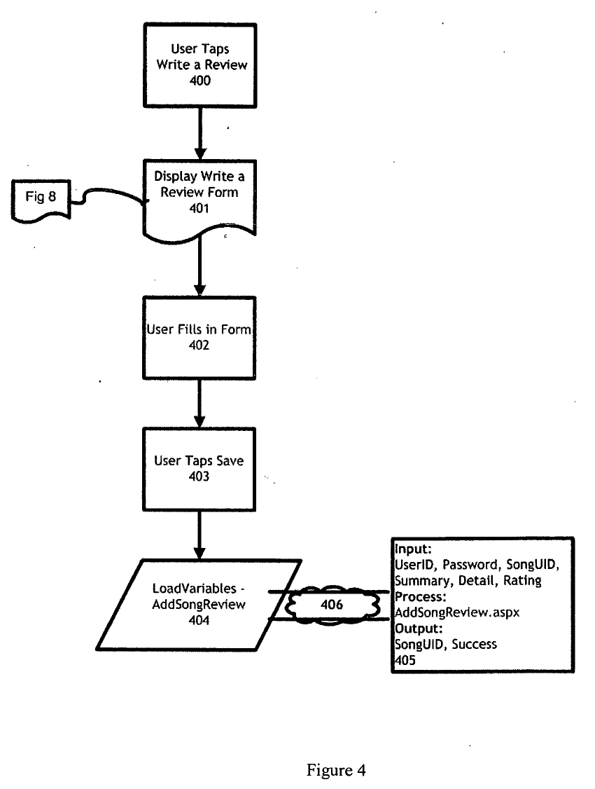

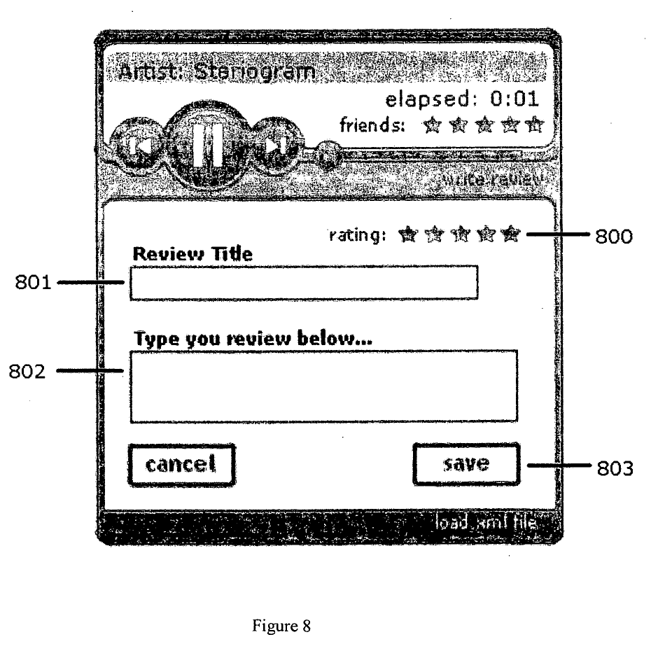

FIG. 1c shows a SNMPS in accordance with one preferred embodiment of the present invention. The SNMPS includes a plurality of mobile digital music players 10, each of which is coupled to a wireless network 60, and in turn to a database service provider 110. The mobile digital music player 10 has a means to communicate over a wireless network 60 to one or more remote servers 80 (only one server 80 is shown in FIG. 1c) of SNMPS in order to retrieve reviews and related information originating from the user's social circle as depicted in FIGS. 2-3 and FIGS. 5-7, as well as to upload review data (FIGS. 4 and 8) to the database service provider 110 originating from the user.

Web server 80 is typically a programmed computer, more specifically one which supports a Hypertext Transfer Protocol (HTTP) that handles request for records, images, documents and other services, and transmits such information over the electronic network 60. Many suitable software programs for Web server 80 exist, including Apache, Microsoft IIS, and Netscape.

SNMPS, in addition to a Web server 80, includes a database connectivity component such as ASP.Net 80, which is a specific server side scripting language product which allows otherwise static information to be created dynamically by providing an interface between Web server 80 and a database server 90 using Microsoft ADO.NET protocol. ADO.NET is well known in the art and therefore will not be further discussed. Other similar server side products could be used such as Oracle Web Sphere.

Database server 90 is generally configured as a SQL database, using software programming such as that available from Oracle, Microsoft, Informix or Sybase and is operable to transmit and receive information between ASP.NET 80 and a database 90 which may be a conventional storage medium, such as a conventional relational database.

FIG. 1d shows another embodiment of a SNMPS in accordance with one preferred embodiment of the present invention. In this embodiment, music files are downloaded directly from the remote database service provider 110 to a mobile device using a physical connection such as a cable or cradle which is connected to a computer which, in turn, is connected to an electronic network 60 such as shown in FIG. 1a. Music files are downloaded from the music download server 111 at the remote database service provider 110 to another mobile device wirelessly, as shown in FIG. 1b.

The computer 70 is coupled to a network 60, and in turn to a database service provider 110. The computer 70, which is shown in detail, is typically a personal computer such as a Microsoft Windows-based workstation, having memory 50 containing communications software which interacts with a mobile device 10 through a physical connection with a cradle or synchronization cable 20. The memory 50 resident software has a means to communicate over a network 60 to one or more remote servers 80 of SNMPS in order to download music files from the music download server 111 at the remote database service provider 110 to the mobile digital music player via a physical connection to a computer 70, as well as to update the remote database service provider 110 as shown through the depicted interfaces.

The mobile digital music player 10 also has a means to communicate over a network 60 to one or more remote servers 80 of SNMPS in order to wirelessly download digital music files from the music download server 111 at the remote database service provider 110 and update the remote database service provider 110 as shown through the depicted interfaces.

FIG. 1e shows another embodiment of a SNMPS in accordance with one preferred embodiment of the present invention. In this embodiment, both music files from a music server 109 at a music download site 108 and reviews from remote servers 80 of SNMPS are downloaded to the mobile device using a physical connection, such as a cable or cradle, connected to a computer which, in turn, is connected to an electronic network.

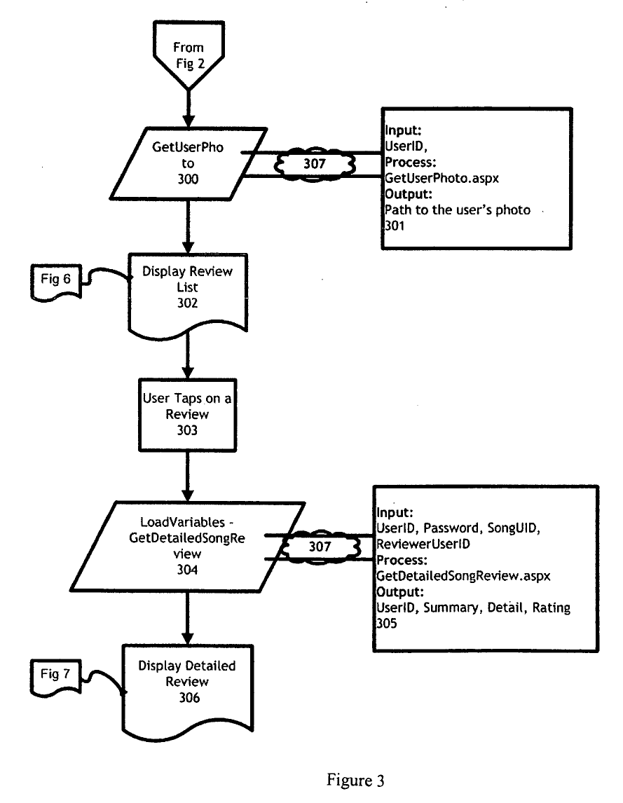

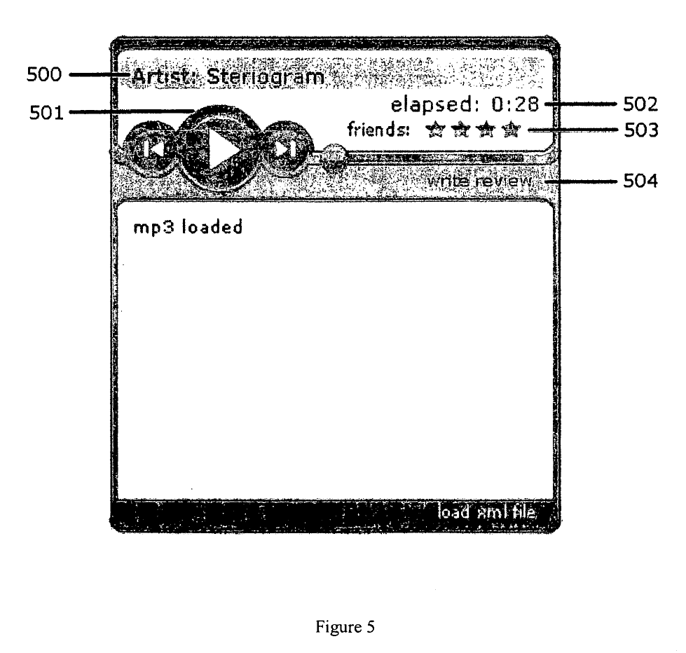

FIG. 2 shows a sequence of events that occur when interacting with SNMPS in accordance with one preferred embodiment of the present invention. The user may launch 200 (see FIG. 5), thereby triggering a transfer of information 201 over a network which supports a Hypertext Transfer Protocol (HTTP) or a TCP/IP protocol 210. The responding Web server 202 executes Subroutine GetAllRatings shown in the Appendix. When the user presses the play button 203 in the user interface depicted in FIG. 5, a sequence is initiated which begins playing the digital music file and also causes the player to retrieve the ID3 tag3 embedded within the file 204. The player compares all song ratings in local memory to find the match with the song being played and locates the ratings information pertaining to the song. It displays the rating in textual or graphical format (FIG. 5, 503). The player executes a request to transfer information 205 over a network which supports a Hypertext Transfer Protocol (HTTP) or a TCP/IP protocol 210. The responding Web server 202 executes Subroutine PlaySong 206 shown in the Appendix. The player executes a request to transfer information 208 over a network which supports a Hypertext Transfer Protocol (HTTP) or a TCP/IP protocol 210. The responding Web server 202 executes Subroutine GetSongsReviews 209 shown in the Appendix. The sequence then continues through FIG. 3.

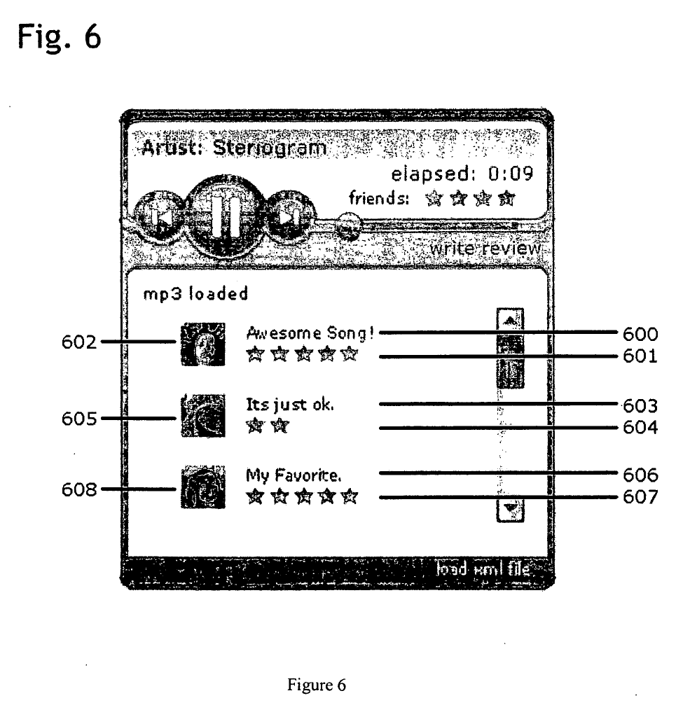

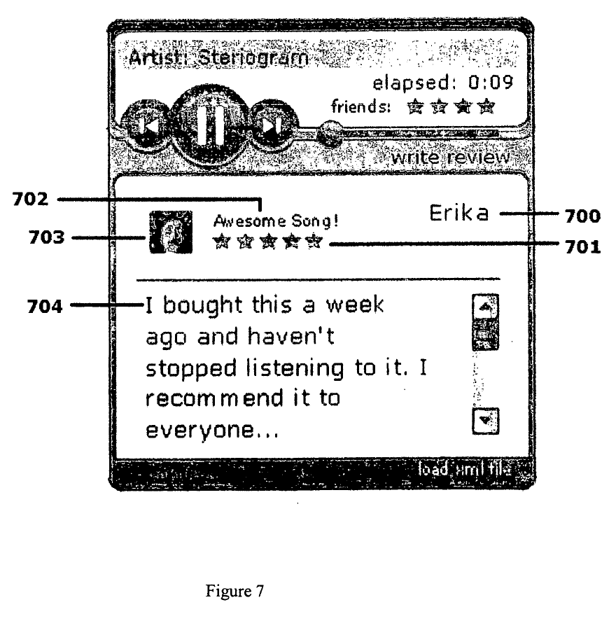

FIG. 3 shows a sequence of events that occur when interacting with a SNMPS in accordance with one preferred embodiment of the present invention. For each review returned from FIG. 2, step 209, the player executes a request to transfer information 300 over a network which supports a Hypertext Transfer Protocol (HTTP) or a TCP/IP protocol 307. The responding Web server 300 executes Subroutine GetUserPhoto 301 shown in the Appendix. The data returned may be of any common digital image format such as jpg, .png, gif or .bmp. Photos returned are displayed alongside their corresponding review summaries in the user interface as depicted in FIG. 6, items 602, 605, 608. Next, the corresponding user interface elements for each song review retrieved by FIG. 2, step 208 including the summary 202 (see FIG. 6, items 600, 603, 606) and ratings (see FIG. 6, items 601, 604, 607) are shown as indicated in FIG. 5. In response to a user tap or selection of a displayed review summary 303, the player executes a request to transfer information 304 over a network which supports a Hypertext Transfer Protocol (HTTP) or a TCP/IP protocol 307. The responding Web server 305 executes Subroutine GetDetailedSongReview 305 shown in the Appendix. The data returned is displayed as depicted in FIG. 7.

FIG. 4 shows a sequence of events that occur when adding a review to a SNMPS in accordance with one preferred embodiment of the present invention. During the playback of any digital music file 400, the user may tap or click a button (FIG. 5, item 504) to trigger the next step in the sequence 401 causing the player to display a data entry form (FIG. 8) which collects the user's review data 402. Upon clicking or tapping 403 a “save” button (FIG. 8, item 803), the player executes a request to transfer information 404 over a network which supports a Hypertext Transfer Protocol (HTTP) or a TCP/IP protocol 406. The responding Web server 405 executes Subroutine AddSongReview 405 shown in the Appendix.

FIG. 5 shows a diagram depicting the player controls of a SNMPS in accordance with one preferred embodiment of the present invention. Playback of digital music files occurs as is common with a series of buttons to start, move to next song, move to previous song and pause playback 501 Routine SNMusicPlayer shown in the Appendix. The display area provides a typical user interface element that may depict the elapsed time 502 as well as artist and album information 500. Additionally, a SNMPS displays social networked information depicting a rating summary which is an average rating of the listener's socially networked group 503. Additionally, this information can scroll among a plurality of information within the area dedicated to the artist and album information 500. Additionally, song summaries as depicted in FIG. 6 may scroll as a plurality of information elements within the same interface area 500. Artist and Album information depicted in user interface element 500 is retrieved commonly from embedded ID3 tags contained within the digital music file. The cumulative social rating for the current song 503 is retrieved from Subroutine GetAllRatings shown in the Appendix. 202. The Write Review 504 interface element triggers the player to display a data form which captures user reviews for the current song (see FIG. 8).

FIG. 6 shows a diagram depicting the review summary display of a SNMPS in accordance with one preferred embodiment of the present invention. The SNMPS displays a series of reviews related to the current song being played. Review summary information is obtained via Subroutine GetSongReviews (shown in the Appendix) over a network which supports a Hypertext Transfer Protocol (HTTP) or a TCP/IP protocol. The player displays the data returned which depicts the ratings (items 601, 604, 607) and the summaries (items 600, 603, 606). Corresponding user photos (items 602, 605, 608) are retrieved over a network which supports a Hypertext Transfer Protocol (HTTP) or a TCP/IP protocol Subroutine GetUserPhoto (shown in the Appendix) for each review summary displayed.

FIG. 7 shows a diagram depicting the review detail display of a SNMPS in accordance with one preferred embodiment of the present invention. In response to the user clicking, tapping or selecting a specific review summary from FIG. 6, the SNMPS requests the review detail data via Subroutine GetDetailedSongReview FIG. 3. 305 (shown in the Appendix) over a network which supports a Hypertext Transfer Protocol (HTTP) or a TCP/IP protocol. The returned data is displayed as depicted with the reviewer name 700, rating 701, review summary 702, photo 703, as returned from GetUserPhoto (shown in the Appendix), and review detail 704.

FIG. 8 shows a diagram depicting the review entry form display of a SNMPS in accordance with one preferred embodiment of the present invention. In response to the user clicking, tapping or selected the Write Review button (FIG. 5, item 504), the player displays a data entry form to capture the review data from the user. Captured elements are as depicted including the rating 800, the summary of the review 801, as well as the detailed review 802. In response to the user clicking, tapping or selecting the save button 803, the player submits a request over a network which supports a Hypertext Transfer Protocol (HTTP) or a TCP/IP protocol calling Subroutine AddSongReview shown in the Appendix.

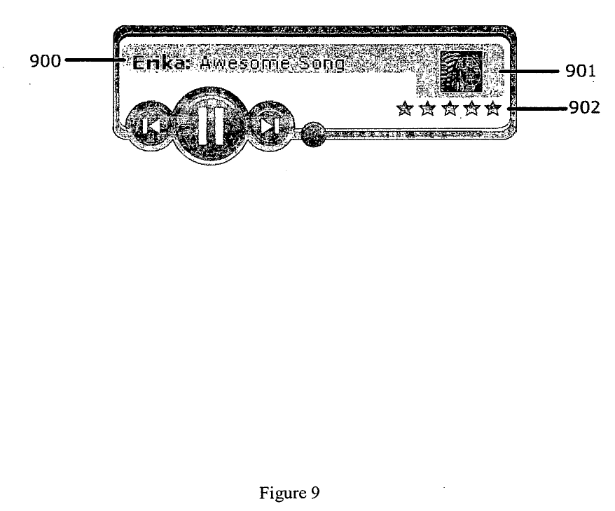

FIG. 9 shows a diagram depicting a compact version of the user interface of a SNMPS in accordance with one preferred embodiment of the present invention. This user interface is similar to the previously described user interface, except that summary reviews created by reviewers in the listeners social circles are depicted in a scrolling or ticker-like fashion in the display area 900—scrolling through as a plurality of reviews along with traditional artist and album information relating to the currently playing digital music file. This information is automatically retrieved and displayed for each digital music file as it begins playing, without the need for user interaction. Additional dedicated areas on the display may show a photo or graphical representation of the reviewer 901 along with their rating depicted in graphical or textual forms 902. One may toggle between the full user interface version and the compact version based on user preferences.

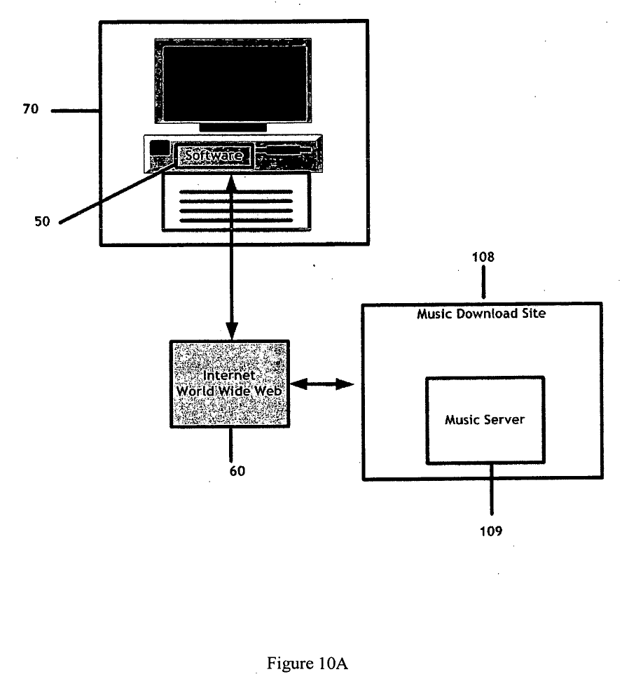

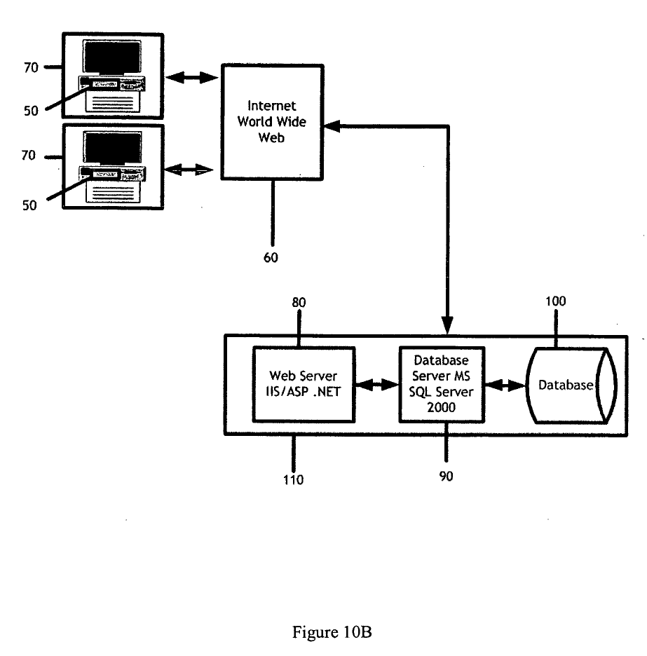

FIG. 10a shows a social networked pc-based digital music player system (SNP) accordance with one preferred embodiment of the present invention.

The computer 70, is coupled to an electronic network 60, and in turn to a music server 109 at a music download site 108, such as Napster or Apple iTunes Music Store. One example of the electronic network is the Internet. The computer 70 is typically a personal computer such as a Microsoft Windows-based workstation, having memory 50 containing the SNP. Digital music files are retrieved by the user through a music download site 108 that incorporates a music server 109 containing a singularity or plurality of digital music files and then stored on the user's personal computer.

FIG. 10b shows a SNP in accordance with one preferred embodiment of the present invention. The SNP includes a plurality of computers 70 having memory 50 containing the SNP, each of which is coupled to a network 60, and in turn to a database service provider 110 which in turn reads and writes stored review data using a database 100. The computer 70 has a means to communicate over a network 60 to one or more remote servers 80 (only one server 80 is shown in FIG. 10b) in order to retrieve reviews and related information originating from the user's social circle as depicted in FIGS. 2-3 and FIGS. 5-7, as well as to upload review data (FIGS. 4 and 8) to the database service provider 110 originating from the user.

Web server 80 is typically a programmed computer, more specifically one which supports a Hypertext Transfer Protocol (HTTP) that handles request for records, images, documents and other services, and transmits such information over the electronic network 60. Many suitable software programs for Web server 80 exist, including Apache, Microsoft IIS, and Netscape.

The SNP, in addition to a Web server 80, includes a database connectivity component such as ASP.Net 80, which is a specific server side scripting language product which allows otherwise static information to be created dynamically by providing an interface between Web server 80 and a database server 90 using Microsoft ADO.NET protocol. ADO.NET is well known in the art and therefore will not be further discussed. Other similar server side products could be used such as Oracle Web Sphere.

Database server 90 is generally configured as a SQL database, using software programming such as that available from Oracle, Microsoft, Informix or Sybase and is operable to transmit and receive information between ASP.NET 80 and a database 90 which may be a conventional storage medium, such as a conventional relational database.

The rating described above is an average rating for all members of the social network. In an alternative embodiment, the rating may be a median rating or some other weighting that may eliminate, emphasize or deemphasize outlier ratings or ratings associated with particular members of the social network.

The rating and review information that is downloaded is only rating and review information associated with the social network. Thus, there may be some music selections in a user's device that would have no rating or review if nobody from the social network submitted a rating or review. If so, the device would indicate “no rating available,” or some other message conveying this fact. In an alternative embodiment, the device would download rating information for non-social network persons stored in the database 100 (referred to herein as a “generic rating”) if no rating information is available for the social network, and the device would indicate that the rating is a generic rating. In one version of this alternative embodiment, no review information would be made available since the reviewers are not associated with the user's social network. That is, one cannot drill down into the generic rating as can be done for the social network rating. In another version of this alternative embodiment, selected reviews would be shown, but no personal identifier information would be shown.

The present invention is described in the context of a social circle for music. However, the present invention can also be used for content that may or may not have music. Examples of such content include audio files other than music, printed matter (e.g., books, articles) for display on a screen, and video files (e.g., movies, television shows). Such content can also have ratings and reviews, and can be played on a digital content player. Printed matter is “played” by viewing and scrolling through the printed matter on a display associated with the digital content player. Thus, in the broadest sense, the present invention provides a social circle that rates and reviews any form of content. The ratings and reviews are then used by members of the social network. More specifically, an average rating for each content item in the user's player is initially downloaded into the digital music player, and then when a specific content item is being experienced (e.g., displayed), detailed review information is downloaded and displayed on the user's player in the same manner as described above for music content.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A social network system comprising:
(a) a first database including:
(i) a plurality of social network circles, each social network circle having a plurality of members,
(ii) ratings for one or more items of digital content, at least some of the ratings being provided by members of the social network circles,
(iii) reviews for one or more items of digital content, at least some of the reviews being provided by members of the social network circles;
(b) a first server connected to the database for handling operations on the database; and
(c) a second server connected to the first server and to an electronic network for facilitating access to the database via the electronic network.

2. The system of claim 1 further comprising a device connected to the electronic network, the device being used by an end user and adapted to play items of digital content.

3. The system of claim 2, wherein the device displays the ratings associated with the played items of digital content, the ratings being provided by members of the end user's social network circle.

4. The system of claim 2, wherein the device displays the reviews associated with the played items of digital content, the reviews being provided by members of the end user's social network circle.

5. The system of claim 1, wherein the reviews further comprise information about one or more reviewers.

6. The system of claim 1, wherein the reviews further comprise one or more reviewers' name.

7. The system of claim 1, wherein the reviews further comprise one or more reviewers' photos.

8. The system of claim 2, wherein the device displays an aggregate rating based on ratings provided by members of the end user's social network circles.

9. The system of claim 2, wherein if there are no ratings provided by members of the end user's social network circle, the device displays an aggregate rating based on ratings provided by members of other social network circles.

10. The system of claim 2, wherein if there are no reviews provided by members of the end user's social network circle, the device displays selected reviews provided by members of other social network circles without any personal identifier information regarding the members of the other social network circles.

11. The system of claim 2 wherein the device includes a user interface adapted to allow the end user to enter ratings for items of digital content played on the device, the ratings being uploaded to the first database.

12. The system of claim 2 wherein the device includes a user interface adapted to allow the end user to enter reviews for items of digital content played on the device, the reviews being uploaded to the first database.

13. The system of claim 2 wherein the device is a wireless mobile device.

14. The system of claim 1 wherein the reviews are textual reviews.

15. The system of claim 1 further comprising a third server connected to a second database that contains at least some of the items of digital content, the third server allowing a member to download the items of digital content via the electronic network.

16. The system of claim 1 wherein the items of digital content include music files.

17. The system of claim 1, wherein the items of digital content include video files.

18. The system of claim 1, wherein the items of digital content include text of a book, magazine or an article.

19. A method for providing ratings and reviews from members of a plurality of social network circles, the ratings and reviews relating to one or more items of digital content, the ratings and reviews provided to an end user over a communication network, comprising:
storing information about one or more members of the social network circle;
storing the ratings for one or more items of digital content, at least some of the ratings being provided by the members of the social network circles;
storing the reviews for one or more items of digital content, at least some of the reviews being provided by the members of the social network circles; and
delivering at least some of the ratings and reviews for the one or more items of digital content and the information about one or more members providing the ratings and reviews to the end user over communication network.

20. The method of claim 19, further comprising delivering the ratings and reviews to a device connected to the communication network, the device being used by the end user and adapted to play items of digital content.

21. The method of claim 20, further comprising displaying the ratings associated with the played items of digital content.

22. The method of claim 20, further comprising displaying the reviews associated with the played items of digital content.

23. The method of claim 20, wherein the information about the members comprise one or more name.

24. The method of claim 20, wherein the information about the members comprise one or more photos.

25. The method of claim 20, further comprising displaying an aggregate rating based on the ratings provided by members of the end user's social network circles.

26. The method of claim 20, further comprising displaying an aggregate rating based on the ratings provided by members of other social network circles.

27. The method of claim 20, further comprising displaying selected reviews provided by members of other social network circles without any personal identifier information regarding the members of the other social network circles.
